(19) United States
(12) Patent Application Publication
(10) Pub. No.: US 2021/0260871 A1
(43) Pub. Date: Aug. 26, 2021

(54) DELAY DEVICES

(71) Applicant: HEWLETT-PACKARD DEVELOPMENT COMPANY, L.P., Spring, TX (US)

(72) Inventors: John ROSSI, Vancouver, WA (US); Scott A. LINN, Corvallis, OR (US); James M. GARDNER, Corvallis, OR (US)

(73) Assignee: HEWLETT-PACKARD DEVELOPMENT COMPANY, L.P., Spring, TX (US)

(21) Appl. No.: 16/772,977

(22) PCT Filed: Feb. 6, 2019
(86) PCT No.: PCT/US2019/016742

§ 371 Date: Jun. 15, 2020

(51) Int. Cl. B41J 2/045

(52) U.S. Cl. CPC B41J 2/04573; B41J 2/04586; B41J 2/04541

(57) ABSTRACT

A method for use with a series of analog delay circuits to drive a plurality of actuators with a fire signal is disclosed. A bias signal to affect a selected delay in the analog delay circuits is disabled. The fire signal is provided through the series of analog delay circuits with the bias signal disabled.

### BACKGROUND

Printing devices can include printers, copiers, fax machines, multifunction devices including additional scanning, copying, and finishing functions, all-in-one devices, or other devices such as pad printers to print images on three dimensional objects and three-dimensional printers (additive manufacturing devices). In general, printing devices apply a print substance often in a subtractive color space or black to a medium via a device component generally referred to as a printhead. Printheads can employ fluid actuator devices, or simply actuator devices, to selectively eject droplets of print substance onto a medium during printing. For example, actuator devices can be used in inkjet type printing devices. A medium can include various types of print media, such as plain paper, photo paper, polymeric substrates and can include any suitable object or materials to which a print substance from a printing device are applied including materials, such as powdered build materials, for forming three-dimensional articles. Print substances, such as printing agents, marking agents, and colorants, can include toner, liquid inks, or other suitable marking material that in some examples may be mixed with other print substances such as fusing agents, detailing agents, or other materials and can be applied to the medium.

### BRIEF DESCRIPTION OF THE DRAWINGS

FIG. 1 is a block diagram illustrating an example method for use with a series of analog delay circuits that drive a plurality of actuators with a fire signal.

FIG. 2 is a block diagram illustrating an example integrated circuit that can be used to drive the plurality of actuators, and implement the example method of FIG. 1.

FIG. 3 is a block diagram illustrating an example fluid ejection device that can include the example integrated circuit of FIG. 2 to implement the example method of FIG. 1.

FIG. 4 is a schematic diagram illustrating an example printing device that can include the example fluid ejection device of FIG. 3.

### DETAILED DESCRIPTION

An inkjet printing system, which is an example of a fluid ejection system, can include a printhead, a print substance supply, and an electronic controller. The printhead, which is an example of a fluidic actuator device or actuator device, can selectively eject droplets of print substance through a plurality of nozzles, each of which can be an example of an actuator, onto a medium during printing. The nozzles can be arranged on the printhead in a column or an array and the electronic controller can selectively sequence ejection of print substance. The printhead can include hundreds or thousands of nozzles, and each nozzle ejects a droplet of print substance in a firing event in which electrical power and actuation signals are provided to printhead. Each nozzle can consume tens of milliamperes (mA) of current during a firing event.

Printheads often stagger the firing events to reduce peak power consumption during printing. Printheads typically employ digital circuits having flip-flops driven with a continuously running clock signal to stagger the firing events. In one example, firing events are staggered in the order of 100 nanoseconds apart. Each firing event can be triggered with a fire signal provided to each nozzle. The fire signal is provided from the digital circuit that may include a logic high, or a signal driven to a selected voltage, for approximately a microsecond to trigger the firing event or actuate the nozzle. Rather than simultaneously actuate hundreds or thousands of nozzles, the digital circuits may simultaneously actuate a dozen or so nozzles.

As printheads and associated circuits get smaller, several circuit architectures are changed. These architecture adaptations have affected how the nozzles are fired and how the firing events are staggered. For example, the circuit architecture may no longer include a continuous running clock available to stagger firing events, and reductions to power routing and circuit area reduce the peak currents that can be tolerated by a printhead die. Instead of a continuous running clock, an on-die integrated circuit to drive a plurality of actuators can include a series of programmable analog delay circuits that can stagger the fire signals provided to the fluid actuators. In one example, a fluid ejection device includes a plurality of actuators that selectively eject a print substance in response to a fire signal. An analog delay circuit receives the fire signal and provides the fire signal to a first output after delay. The first output is coupled to a first actuator and a successive analog delay circuit in the series. The successive analog delay circuit receives the fire signal from the first output and provides the fire signal to a second output after delay. The second output is operably coupled to another actuator. A bias circuit provides a bias signal to the analog delay circuits to control the delay. Analog delay circuits, however, can introduce distortions into the waveform of the fire signal and are susceptible to variations of delay across different operating conditions, such as environmental conditions. Such deviations can compromise health monitoring of the printhead.

The disclosure is directed to circuits and methods of selectively deactivating the delay component of the series of analog delay circuits, such as selectively deactivating the delay component of the series of analog delay circuits while the actuators are in use. For example, the disclosure is directed to a circuits and method to selectively deactivate the delay component of the analog delay circuits when the analog delay circuit is subjected to a fire signal and the actuators are used to eject the print substance in which the delay component can be deactivated and activated on a per fire signal basis. The actuators can be coupled to a test circuit, which may be provided on another integrated circuit that is operably coupled to the actuators, to perform various tests. For instance, the test circuit can be used to detect the current draw of the actuators. The test circuit can detect a change in current over time, which is sharpened with a fire pulse more quickly moving through the analog delay circuits with the delay component deactivated. In another example, the series of analog delay circuits can be coupled to the test circuit. For example, the test circuit can be coupled to the output of the final analog delay circuit in the series. The test circuit, in this example, can be used to determine the health or timing of the fire signal.

During operation, a fire signal is used in correspondence with a data signal applied to the nozzles to selectively eject print substance. The actuators receive a sequence of fire signals and data sets to repeatedly eject the print substance. Configuration logic can be used to selectively disable the bias signal, and the fire signal is passed through the series of the analog delay circuits without a controlled delay and relatively quickly. In one example, a configuration signal, which may be included in a data packet with the data signal, is used to disable the bias signal. The fire signal is passed through the series of analog delay circuits. The bias signal circuit can be enabled with a subsequent configuration signal corresponding with a subsequent fire signal, and the actuators can resume operation with the subsequent fire signal.

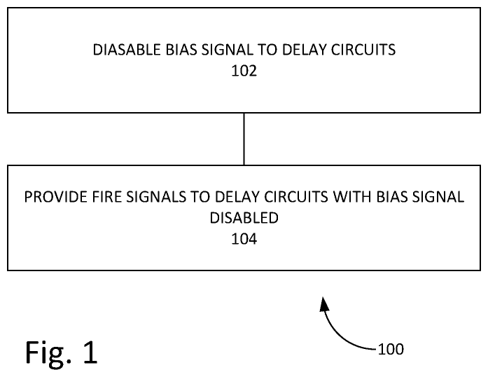

FIG. 1 illustrates an example method 100 that can be used with a series of analog delay circuits that drive a plurality of actuators with a fire signal. A bias signal is used to affect a selected delay in analog delay circuits of the series of analog delay circuits. For example, the bias signal affects a selected delay in the analog delay circuits to stagger the application of the fire signal to the plurality of actuators. The bias signal provided to each of the analog delay circuits is disabled at 102. The fire signal is provided through the series of analog delay circuits with the bias signal disabled at 104. In one example, the fire signal can be included in a sequence of fire signals provided to the analog delay circuits. In this example, the bias signal is disable for the fire signal of the sequence of fire signals. The sequence of fire signals can include a corresponding sequence of data signals provided to the plurality of actuators. In one example, the data signals can control whether the actuators will fire in response to the fire signal and which actuators of the plurality of actuators will fire in response to the fire signal. In one example, a data packet including a data signal that corresponds with the fire signal can also include a configuration signal to disable the bias signal. A subsequent configuration signal in a data packet corresponding with a subsequent fire signal in the sequence of fire signals can enable, or re-enable, the bias signal. In this example, the bias signal can be disabled or enabled on a per fire signal basis. In one example, the amount of current drawn in the actuators while the bias signal is disabled is detected and measured with test logic. In another example, the fire signal is measured with a controller to determine the status or health of features of analog delay circuits.

The example method 100 can be implemented to include hardware devices, programs, or hardware device and programs for controlling a system having a processor and memory, that can selectively disable a bias circuit and measure a fire signal passed through a series of analog delay circuits. For example, method 100 can be implemented in an integrated circuit that can receive a fire signal and a configuration signal to disable the bias signal. In one example, the signals or currents from the actuators or analog delay circuits can be measured with a hardware system, such as an application specific integrated circuit (ASIC), or a hardware system and program operably coupled to a printhead system.

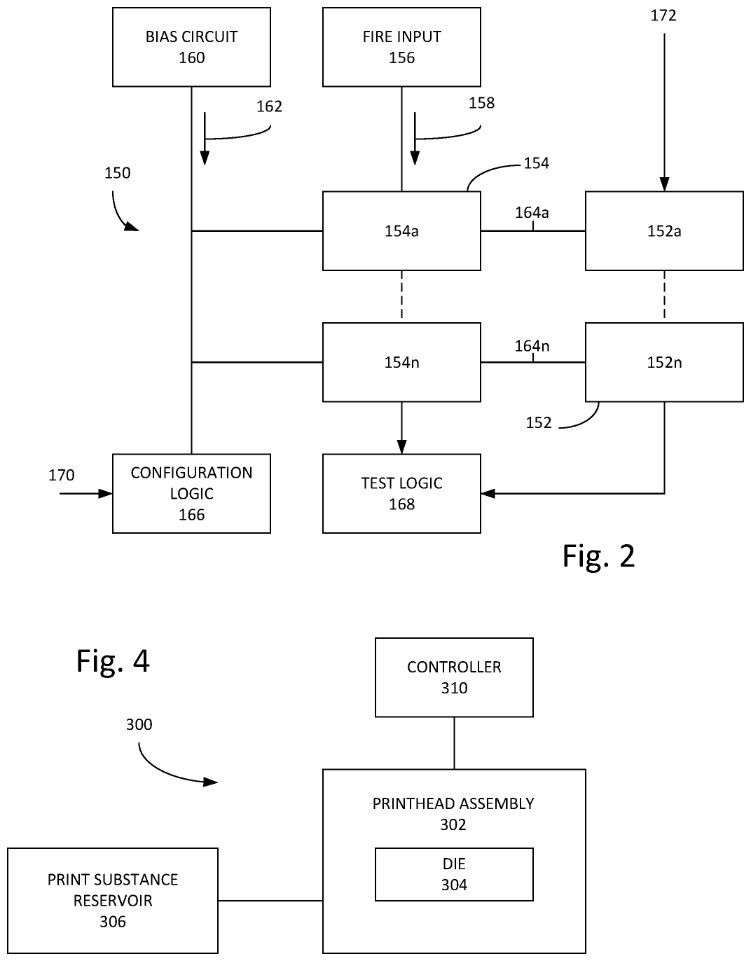

FIG. 2 illustrates an example integrated circuit 150 to drive a plurality of actuators 152 that can implement method 100. The plurality of fluid actuators 152 can include fluid actuators 152a . . . 152n. The integrated circuit 100 includes a plurality of analog delay circuits 154 coupled together in series, including analog delay circuits 154a . . . 154n, fire logic 156 to provide a fire signal 158 to the analog delay circuits 154, a bias circuit 160 to control the delay of each of the analog delay circuits 154a . . . 154n with a bias signal 162, configuration logic 166 to receive a configuration signal 170 and selectively disable the bias signal 162, and signal pad 168 operably coupled to the actuators 152 to receive signals from the actuators 152.

Each of the analog delay circuits 154a . . . 154n produces an output waveform similar to its input waveform but delayed by a selected amount of time. The plurality of analog delay circuits 154 coupled together in series and also coupled to fire logic 156, which can provide the fire signal 158 to the analog delay circuits 154. In one example, the fire logic 156 can produce a sequence of fire signals. Each of the of the analog delay circuits 154a . . . 154n of the plurality of analog delay circuits 154 receives the fire signal 158, and after a delay, provides the fire signal 158 via an output 164a . . . 164n of a plurality of outputs 164 to a corresponding fluid actuator 152a . . . 152n to trigger or actuate a firing event in the fluid actuator 152a . . . 152n. For example, an analog delay circuit of the plurality of analog delay circuits 154 is coupled in series to a successive analog delay circuit of the plurality of analog delay circuits 154. The analog delay circuit receives the fire signal 158, and after a local delay, provides the fire signal 158 to a corresponding fluid actuator of the plurality of fluid actuators 152 and to the successive analog delay circuit. The successive analog delay circuit receives the fire signal 158, and, after a local delay, provides the fire signal 158 to a corresponding fluid actuator of the plurality of fluid actuators 152. In one example, the fire signal 158 is a waveform having a logic voltage, such as a logic high voltage between about 1.8 volts and 15 volts, for a selected amount of time, such as 1 microsecond, to actuate a fluid actuator of the plurality of fluid actuators 152.

In one example, a fire signal 158 provided to the series of analog delay circuits 154 can correspond with a data signal 172 provided to the actuators 102. The data signal 172 can be included in a data packet with the configuration signal 170, and the data signal 172 can control the whether the actuators 152 will fire in response to the fire signal and which actuators 152a . . . 152n of the plurality of actuators 152 will fire in response to the fire signal 158. In one example, the data signal 172 can load the actuators for firing based on such parameters including the location of the printhead with respect to a medium, the shape of the image to be printed, and the color of the image to printed. A sequence of fire signals 158 provided from the fire logic 156 to the analog delay circuits 154 can correspond with a sequence of data signals provided to actuators 152 to selectively eject a fluid from the actuators 152. In one example, each fire signal in a sequence of fire signals can correspond with a data signal in the sequence of data signals, the analog delay elements 154 and actuators 152 can receive a sequence of fire signal and data signal pairs to selectively eject fluid, such as a print substance to print an image on a medium.

The bias circuit 160 is operably coupled to each of the analog delay circuits 154a . . . 154n. The bias circuit 160 provides the bias signal 162 to each of the analog delay circuits 154a . . . 154n to control the delay. In one example, the bias signal 162 can be a control voltage that provides an amount of delay in each of the analog delay circuits 154a . . . 154n to the fire signal 158 prior to the fire signal 158 provided at the output 164a . . . 164n. The control voltage of the bias signal 162 can be a continuous control voltage. In some examples, the bias signal 162 can be a control current, such as a continuous control current. The bias signal 162 provided to the analog delay circuits 154 can be selected from a plurality of bias signals that can be generated by the bias circuit 160. In this example, a length of the delay in an analog delay circuit 154 is variable. Each of the plurality of bias signals that can be provided to the analog delay circuits 154 can provide a different amount of delay in the analog delay circuits 154. In one example, a single bias signal 162 can be output from the bias circuit 160, but that single bias signal 162 can be selected from a plurality of available bias signals that can be generated by the bias circuit 160. The bias circuit 160 can programmably adjust a length of the delay of the analog delay circuits 154a . . . 154n via the bias signal 162. Bias circuit 160 can be used to finely adjust delay of the analog delay circuits 154 as well as adjust delay for various print speed modes of a printhead system. In one example, configuration logic circuit 166 can be included as part of the bias circuit 160 to receive the configuration signal 170 and selectively disable or enable the bias signal 162.

The signal pad 168 can be an electrical pad that is electrically coupled to circuits of the integrated circuit 150, such as the actuators 152, to receive signals, such as currents from the actuators 152. The signal pad can include a dimple flex connection that is operably coupleable to a test logic that can be configured to detect and measure electrical signals from the integrated circuit 150. For instance, the test logic can be configured to detect and measure electrical signals from the integrated circuit 150 during operation of the actuators 152 and analog delay circuits 154. In one example, the test logic is located in a separate integrated circuit device that electrically coupled to integrated circuits 150 via signal pad 168.

The analog delay circuits 154 are characterized by producing an output waveform similar to the input waveform, such as an input fire signal 158, but locally delayed by a selected amount of time. In general, this selected amount of time is variable and is based upon a selected input control voltage, such as a continuous control voltage. For instance, a first amount of continuous control voltage provides a first amount of delay and a second amount of continuous control voltage, which is different than the first amount of continuous control voltage, provides a second amount of delay that is different than the first amount of delay. In this example, the bias signal 162 provides the continuous control voltage. Example analog delay circuits 154 can employ a shunt capacitor technique, a current starved technique, or a variable resistor technique. In some examples, analog delay circuits 154 can be configured from cascaded delay circuit elements, such as a cascaded current starved inverter. An output of an analog delay circuit having current starved inverter circuit is provided as an input of a successive current starved inverter in a successive analog delay circuit. Analog delay circuits 154 are not characterized by receiving a free running clock signal.

In one example, each analog delay circuit 154a . . . 154n includes a current starved inverter circuit configured to receive a supply voltage V_{DD} and a bias signal 162 as control voltage V_{CTRL}. In one example, the current starved inverter circuit is configured to receive two simultaneous control voltages during operation. The bias signal 162 having a control voltage V_{CTRL} can include a plurality of control voltages such as control voltages V_{CP} and V_{CN}, during operation and to receive an input fire signal 158 on an input line. Each analog delay circuit 154a . . . 154n is also configured to provide an output fire signal 158 on an output line. The control voltages V_{CP} and V_{CN} provided to the current starved inverter determine an amount of delay applied to the input fire signal prior to providing the output fire signal. For instance, an amount of difference between the control voltages V_{CP} and V_{CN} affects the amount of delay. A relatively larger difference between the control voltages V_{CP} and V_{CN} can provide a relatively longer delay, and a relatively smaller difference between the control voltages V_{CP} and V_{CN} can provide a relatively shorter delay. The bias circuit 160 provides the control voltages V_{CP} and V_{CN} from a programmable input. In one example, the bias circuit 160 includes a digital-to-analog converter to receive the programmable input and to output a corresponding bias signal 162 as a set of continuous control voltages V_{CP} and V_{CN}. In one example, the digital-to-analog converter is a five-bit digital-to-analog converter that can receive a five-bit digital signal as the programmable input and output one of thirty-two control voltage outputs, such as one of thirty-two control voltages V_{CTRL} or one of thirty-two sets of control voltages V_{CP} and V_{CN} to control an amount of delay of the analog delay circuits 164.

Compared to traditional delay circuits based on free running clock, analog delay circuits 154 self-generate delay of the fire signal 158. Each analog delay circuit 154a . . . 154n, however, can produce deformations in the fire signal waveform and is susceptible to variations of delay due to combinations of voltage, temperature, silicon process speed, delay strength, and, in examples of the integrated circuits 150 used in printing systems, print density. In the example of printing systems, it has been discovered that such variations in delay are negligible in producing print substance drop placement and print quality.

To detect the health of signals in the integrated circuit 150 provided to signal pad 168, the configuration logic 166 can provide for a delay bypass on a per fire signal 158 basis via method 100. For instance, fire logic 156 can provide a sequence of fire signals 158 to the analog delay circuits 154. In correspondence with a fire signal 158 produced with the fire logic 156, the configuration logic 166 can receive a configuration signal to selectively disable the bias signal 162 at 102. With the bias signal 162 disabled at 104, the fire signal 158 is passed through the series of analog delay circuits 154 at a relatively faster pace than with the bias signal 162 provided to the analog delay elements 154. Signals, such as currents from the actuators 154 when fired in response to the relatively faster paced fire signal 158, can arrive at the signal pad 168 with parameters, such as timing or waveforms, that may be particularly suited for the test logic. After the fire signal 158 has passed through the series analog delay circuits 154, the configuration logic 166 can enable, or re-enable, the bias signal 162 to the analog delay circuits 158, and a subsequent fire signal in the sequence of fire signals produced with the fire logic 156 can be applied to drive the plurality of actuators 152 under regular operation. In the example, the health monitoring of the integrated circuit 150 can be employed during operation without appreciable affect on performance of the actuators 152.

In the example, the configuration signal 170 can be provided to the integrated circuit 150 as part of a fire signal/data packet pair applied to the series of analog delay elements 154 and the actuators 154 to load and fire the actuators 154. For example, the configuration signal can be included as a flag bit in a digital data packet. The configuration logic 166 can disable the bias signal 162 upon detection of the presence, or absence, of the flag bit. For example, the configuration logic 166 may disable the bias circuit 160 or may open a switch between the bias circuit 160 and the analog delay circuits 154 to prevent the bias signal 162 from reaching the analog delay circuits 154. In a subsequent fire signal/data packet pair applied to the series of analog delay elements 154 and the actuators 154 in a sequence of fire signal/data packet pairs, a subsequent configuration signal can cause the configuration logic 166 to re-enable the bias signal 162 such that the analog delay circuits 154 can resume a selected delay.

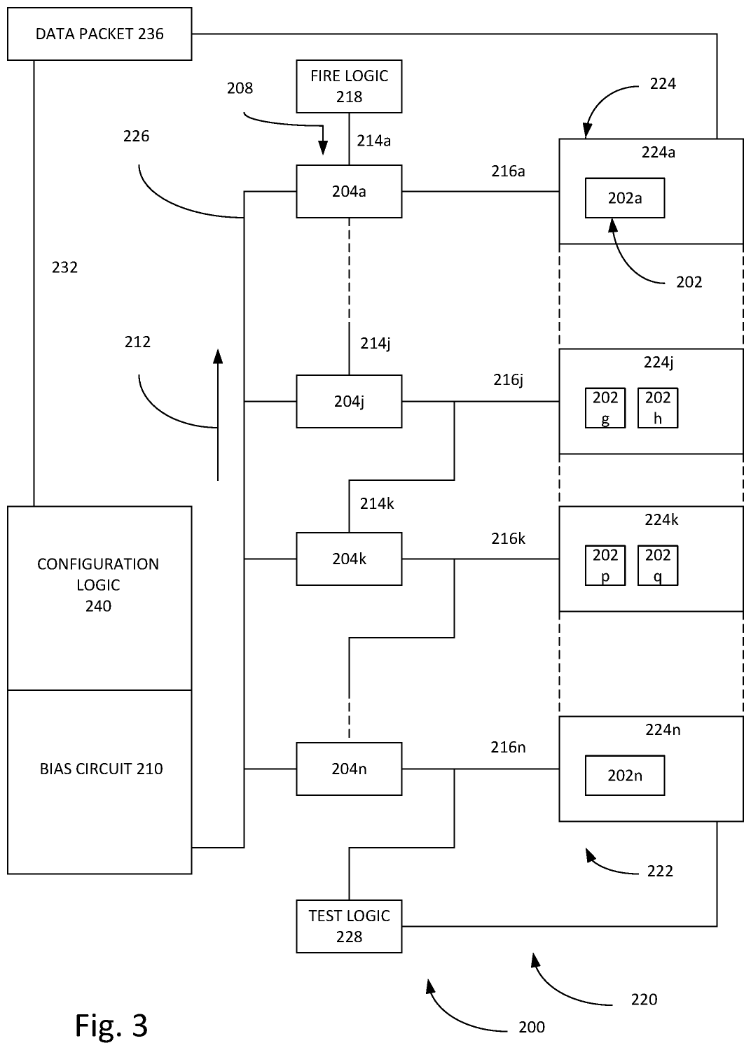

FIG. 3 illustrates an example fluid ejection device 200 that can implement the example integrated circuit 150. One example of a fluid ejection device 200 can include a printhead system for a printing device; and the printhead system can include an integrated printhead (IPH), such as a printhead integrated with a container of print substance, or the printhead system can include a printhead integrated with a printing device. Examples of the fluid ejection device 200 described with reference to a printhead system for ejecting a print substance are for illustration. The fluid ejection device 200 includes a plurality of fluid actuators 202, a plurality of analog delay circuits 204, a configuration logic circuit 240, and a bias circuit 210. The plurality of fluid actuators 202, plurality of analog delay circuits 204, configuration logic circuit 240, and the bias circuit 210 can be included on a fluid ejection die 220 of the fluid ejection device 200. The fluid ejection device 200 can be configured to receive a fire signal 208 from fire logic circuit 218 and receive a configuration signal 232 from a controller, and the fluid ejection device 200 can be configured to provide a signal from the plurality of actuators 202, such as a current used to drive the plurality of actuators 202 or, in some examples, the plurality of analog delay circuits 204, such as the fire signal 28, to test logic electrical output 228.

The fluid ejection device 200 can include the plurality of actuators 202 arranged as an actuator device 222 along a column of the fluid ejection die 220. In one example, the plurality of actuators 202 of the actuator device 222 can be configured to eject a print substance of a single color, such as a black print substance, and operably coupled to a print substance reservoir, which may be included on the fluid ejection device 200. The fluid ejection device 200 may include a plurality of dice in which each die is configured to eject a print substance from a set of print substances, such as print substances of a subtractive color space, and each die of the plurality of dice can be operably coupled to a print substance reservoir of a plurality of print substance reservoirs, which may be included on the fluid ejection device 200. In one example, the fire logic circuit 218 and test logic circuit 228 are located remote from the fluid actuator device 200 or the fluid ejection die 220, or off-die, and the fluid ejection device 200 or fluid ejection die 220 include couplings, such as conductive pads, that can be operably coupled to receive the fire signal 208 from the fire logic circuit 218, receive a data packet 236 including the configuration signal 232 and a data signal 238 from a controller, and provide the signals from the actuator device 222 to the test logic electrical output 228.

The plurality of analog delay circuits 204 are configured to drive the plurality of fluid actuators 202 with a fire signal 208, which triggers a firing event in the fluid actuators 202 to eject a fluid such as a print substance. Each of the fluid actuators 202a . . . 202n corresponds with an analog delay circuit 204a . . . 204n, and each fluid actuator 202a . . . 202n is configured to receive the fire signal 208 from the corresponding analog delay circuit 204a . . . 204n. In one example, the number of fluid actuators 202 may be different than the number of analog delay circuits 204. For instance, the number of fluid actuators 202 may be greater than the number of analog delay circuits 204, and an analog delay circuit 204 may correspond with a plurality of fluid actuators of the plurality of fluid actuators 202. The plurality of analog delay circuits 204 are also coupled together in series to pass the fire signal 208 from one analog delay circuit to another analog delay circuit. The fire signal 208 is locally delayed at each analog delay circuit 204 as it is passed through the plurality of analog delay circuits 204 in series.

The bias circuit 210 provides a bias signal 212 to each of the plurality of analog delay circuits 204 to locally control an amount of delay of the fire signal 208 as the fire signal 208 is passed through the analog delay circuits 204. In one example, the bias circuit 210 can be operably coupled to the analog delay circuits 204 via line 226 to provide bias signal 212. The bias circuit 210 can adjust the bias signal 212, such as adjust a voltage or a current of the bias signal 212, to adjust an amount of delay provided with the analog delay circuits 204. In one example, the bias circuit 210 can select a bias signal 212 from a plurality of bias signals each having a different magnitude of voltage or current, to adjust the amount of delay provided with the analog delay circuits 204. In one example, the bias circuit 210 can adjust the total amount of delay from between 1 microsecond to 5 microseconds, and an appropriate total amount of delay can be selected based on a factor such as a print mode speed of the fluid ejection device 200. The total amount of delay can be selected to be short enough to allow the final analog delay circuit 204n to output a fire signal before a new fire signal is provided to the initial analog delay circuit 204a. Also, the total amount of delay can be selected to be long enough so that few analog delay circuits 204a . . . 204n are simultaneously outputting fire signals 208 to the fluid actuators 202 to reduce peak currents from firing events. The total amount of delay can also be selected based on other factors such as rate of change of current per time, or ∂i/∂t. For example, longer delays can reduce peak currents that can decrease the rate of change of current per time, which can reduce current supply droop and electrical noise in the fluid ejection die 220.

Each analog delay circuit 204a . . . 204n can receive an input waveform on an input line and, after a delay, produce an output waveform on an output line. The analog delay circuits 204 are coupled together in series such that an output line of an analog delay circuit of a sequence is linked to the input line of a successive analog delay circuit of the sequence. The output waveform of each analog delay circuit 204a . . . 204n is similar to the input waveform of the analog delay circuit but is locally delayed by a selected amount of time as controlled by the bias signal 212. In the illustration, the plurality of analog delay circuits 204 include first analog delay circuit 204j and second analog delay circuit 204k coupled together in series in a sequence. First analog delay circuit 204j includes a first input line 214j and first output line 216j. Second analog delay circuit 204k includes a second input line 214k and a second output line 216k. Second input line 214k is coupled to first output line 216j such that the second analog delay circuit 204k receives an input waveform provided as the output waveform from the first analog delay circuit 204j. An initial analog delay circuit 204a in the sequence includes an initial input line 214a operably coupled to a fire logic circuit 218, which can provide a fire signal 208 on input line 214a, and the fire signal 208 is sequentially passed through the analog delay elements 204 to a final output line 216n of a final analog delay circuit 204n.

The fluid actuators 202 are configured to receive a fire signal 208 to trigger firing events as well as a data signal 238 to determine which actuators 202 will produce firing events per fire signal 208 or whether an actuator will produce a firing event per fire signal 208. Each fluid actuator 202a . . . 202n is operably coupled to the output line 216a . . . 216n of a corresponding analog delay circuit 204a . . . 204n to receive a fire signal 208. In the illustrated example, a plurality of fluid actuators, such as fluid actuators 202g and 202h, are operably coupled to an output line of a corresponding analog delay circuit, such as output line 216j of analog delay circuit 204j. Also in the illustrated example, fluid actuators 202p and 202q are operably coupled to output line 216k of analog delay circuit 204k. The data signal 238 can be received from an off die controller and can be provided in the form of a multi-bit digital signal that can select actuators to be fired with the fire signal 208. In one example, fire signals can be provided to the series of analog delay circuits 204a . . . 204n and to the actuators 202a . . . 202n via output lines 216n . . . 216n as a sequence of fire signals. Data signal 238 can be provided as a sequence of data signals to the actuators 202. Firing events in the actuators 202 are triggered with a fire signal/data signal pair in a sequence of fire signal/data signal pairs. For example, if a given data signal received at an actuator, such as actuator 202j, indicates the actuator 202j is to be fired, a firing event will occur in actuator 202j with the receipt of fire signal 208 from output 216j. If the given data received at actuator 202k indicates that actuator 202k is not to be fired, a firing event will not occur in actuator 202k with the receipt of fire signal 208 from output 216k. If a data signal in the subsequent fire signal/data signal pair of the sequence of the sequence of fire signal/data signal pairs indicates that actuators 202j, 202k are to be fired, a firing event will occur in actuators 202j, 202k with the receipt of the corresponding fire signal. The firing event is driven by a current provided to the actuators 202j, 202k.

The plurality of actuators 202 can be arranged into a plurality of actuator primitives, or primitives 224, on the actuator device 222. For example, a selected number of proximate fluid actuators, such as fluid actuators 202g, 202h, can comprise a primitive 224j of the plurality of primitives 224. Primitive 224k can include fluid actuators 202p, 202q. The plurality of primitives 224 may be arranged along an axis of the column of the die 220 as primitives 224a to 224n. Each actuator 202 in a primitive 224 is assigned an address. In one example, each primitive 224 may include sixteen proximate fluid actuators 202 and the sixteen fluid actuators 202 on each primitive 224 can each be assigned an address from 0×0 to 0×F. In one example, one actuator 202 of a primitive 224 is selected at a time for ejecting a fluid as determined by the address. A controller can select the address and provide it to the primitives 224 via the data signal 238. The controller can be located on the fluid ejection device 200 or can be remote from the fluid ejection device and provide a signal, such as a multi-bit control word in the data signal 238, to the fluid ejection device 200 to select the address. In one example, the selected address is applied to each primitive 224 on the actuator device 222. In this example, each analog delay circuit 204a . . . 204n corresponds with a primitive 224a . . . 224n, and each output line 216a . . . 216n of a corresponding analog delay circuit 204a . . . 204n is operably coupled to the corresponding primitive 224a . . . 224n. For instance, each output line 216a . . . 216n of a corresponding analog delay circuit 204a . . . 204n is operably coupled to the fluid actuators 202 comprising the corresponding primitive 224a . . . 224n. A fire signal 208 provided on the output line 216a . . . 216n triggers a firing event in a fluid actuator 202 of the corresponding primitive 224 as selected by the address.

The fire signal 208 can be provided to the initial analog delay circuit 204a and passed through the plurality of analog delay circuits 204 and provided to primitives 224 to trigger firing events in the fluid actuators 202 corresponding with a selected address. For example, a fire signal 208 can be provided to input line 214j and analog delay circuit 204j can locally delay the fire signal 208 and provide the fire signal 208 on output line 216j to primitive 224j. In this example, a controller can select an address assigned to fluid actuator 202g of primitive 224j. Upon receiving the fire signal 208 at primitive 224j, a firing event is triggered in fluid actuator 202g to eject fluid from fluid actuator 202g. The fire signal 208 provided on output line 216j is also provided to input line 214k, and analog delay circuit 204k can locally delay the fire signal 208 and provide the fire signal 208 on output line 216k to primitive 224k. In this example, a controller can select an address assigned to fluid actuator 202p of primitive 224k. Upon receiving the fire signal 208 at primitive 224k, a firing event is triggered in fluid actuator 202p to eject fluid from fluid actuator 202p. In this example, after the fire signal 208 has been output from the final analog delay circuit 204n, the controller can select another address (such as the next address in succession) and another fire signal can be provided to the initial analog delay circuit 204a and passed through the plurality of analog delay circuits 204 and provided to primitives 224. Firing events in the primitives 224 are staggered as the fire signal 208 is passed through the sequence of analog delay circuits 204, and peak currents are reduced compared to simultaneously firing all primitives. The amount of peak current consumed in the die 220 can be selected by adjusting the amount of delay in the analog delay circuits 204 with the bias circuit 210. A long delay relatively reduces peak currents and a short delay relatively increases peak currents in the die 220 during the firing events.

The data signal 238 provided to each primitive 224 can include a set of information including the selected primitives 224a . . . 224n to be fired and the primitive address of the actuator, such as actuator 202g or actuator 202h or such as actuator 202p or actuator 202q, to be fired in the selected primitives. For example, data in the data signal 238 can thus include an address of the primitives 224 to be fired as well as whether an actuator 202g, 202p at that primitive 224j, 224k is to be fired with a fire signal 208 from output lines 216j, 216k. The data signal 238 can be included in a data packet 236 that is provided to the actuator device 222. The data signal 238 may be provided to the actuator device 222 with a corresponding fire signal 208 in a fire signal/data signal pair to cause firing events in the actuator device 222. The data packet 236 including the data signal 238 may be part of a sequence of data packets. In one example, a data packet 236 can include a header, a tail, information regarding which primitives to fire, information regarding the primitive address to be fire, and other data.

The data packet 236 in this example can include the configuration signal 232 that can be provided to the configuration logic circuit 240 to indicate whether enable or disable the bias signal 212. For example, the configuration signal 232 can be a logic signal, such as a voltage high signal in a series of bits in the data packet 236 that directs the configuration logic circuit 240 to disable the bias signal 212. The configuration logic circuit 240 is operably coupled to the bias circuit 210 to enable or disable the bias circuit up receipt and direction of the configuration signal 232. In one example, the configuration logic circuit 240 is incorporated into the bias circuit 210. The configure logic circuit 240 can control the bias circuit 210 or selectively disable the bias signal 212 from reaching the analog delay elements 204. In one example, the amount of delay in each analog delay circuit 204a . . . 204n can be reduced from about 50 nanoseconds to 100 nanoseconds with the bias signal 212 enabled to about 5 nanoseconds with the bias signal 212 disabled to drive the actuators during a test. A subsequent data packet in a sequence of data packets can include a configuration signal to direct the configuration logic circuit 240 to enable, or re-enable, the bias signal 212, and the amount of delay in each analog delay circuit 204a . . . 204n can be increased from about 50 nanoseconds to 100 nanoseconds to resume driving the actuators 202 in normal operation. In this example, the bias signal 212 can be disabled or enabled with each data packet 236 provided to the actuator device 222, and the bias signal 212 can be enabled or disabled on a per data packet basis.

With the bias signal 212 enabled, the fluid ejection device 200 can be configured to operate in a regular mode to eject a fluid such as the print substance, but with the bias signal 212 disabled, the fluid ejection device 200 can be configured to operate in a test mode. The test logic electrical connection 228 can receive the current provided to the actuators 202 during the firing events, determine selected parameters of the current provided to the actuators 202 during the firing events that may be used to determine the health of components on the die 220. With the bias signal 212 disabled, the fire signal 208 is passed through analog delay elements 204 more quickly and the current provided to the actuators during the firing events may arrive at the test logic electrical connection 228 with a particularly sharpened waveform of ∂i/∂t than with the bias signal 212 enabled and the fluid ejection device operating in regular mode. In one example, test logic coupled to the test logic electrical connection 228 is configured to obtain real-time measurements of the current.

FIG. 4 illustrates an example printing device 300 that can employ the fluid ejection device 200 or integrated circuit 100. Printing device 300 includes a fluid ejection device, such as a printhead assembly 302, which can be constructed in accordance with fluid ejection device 200 and include integrated circuit 100. Printhead assembly 302 includes a fluid ejection die 304 to eject a print substance for printing or marking on media. The fluid ejection die 304 can be constructed in accordance with die 220. In one example, the printhead assembly 302 includes a plurality of fluid ejection dice to eject a plurality of print substances, such as a print substances having color in the subtractive color space and a black print substance. The printing device 300 can include a print substance reservoir 306 to store and provide the print substance to the printhead assembly 302. In one example, the print substance reservoir 306 can be included as part of the printhead assembly 302. In another example, the print substance reservoir 306 can be remote from the printhead assembly 302 and may be operably coupled to the printhead assembly 302 via tubing, valves, or pumps. In some examples, the print substance reservoir can include a refillable reservoir that may be filled with a print substance from a print substance supply.

Printing device 300 includes a controller 310 operably coupled to the printhead assembly 302. The controller 310 can include a combination of hardware and programming such as firmware stored on a memory device. The controller 310 can receive signals regarding a file, such as a digital document, to be printed, and provide signals to the printhead assembly 302. In one example, portions of the controller 310 can be distributed on hardware or programming throughout the printing device, and portions of the controller 310 can be included on printhead assembly 302. In one example, the controller 310 can incorporate features of fire logic circuit 218, and logic to generate data packet 236 with configuration signal 232 and data signal 238. The controller 310 can provide data signals 238 to the actuator device 222, can provide signals to the bias circuit 210 to program the bias signal 212, can provide the fire signal 208 to the analog delay circuits 204, and can provide the configuration signal 232 to the configuration logic circuit 240 to enable or disable the bias signal 212 from the bias circuit 210. In one example, the controller 310 can receive signals from the actuators 202 and analog delay circuits 204 to determine the status and health of components of the printhead assembly 302. In one example, the printhead assembly 302 can include conductive pads configured to mate with conductors on the printing device 300 such that the controller 310, or portions of the controller 310, can communicate with a printhead assembly 302 that can be removably coupled to the printing device 300.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1-15. (canceled)

16. A method for use with a series of analog delay circuits to drive a plurality of fluidic actuators with a fire signal, the method comprising:
disabling a bias signal to each of the analog delay circuits, the bias signal to affect a selected delay in the analog delay circuits; and
providing the fire signal through the series of analog delay circuits with the bias signal disabled.

17. The method of claim 16 wherein the bias signal is disabled with a configuration signal.

18. The method of claim 17 wherein the bias is enabled with a subsequent configuration signal.

19. The method of claim 17 wherein the configuration signal is provided with a data packet, and the data packet includes a data signal provided to the plurality of actuators.

20. The method of claim 19 wherein the data packet is included in a sequence of data packets.

21. The method of any of claim 16 wherein a current drawn with the actuators with the bias signal disabled is measured.

22. A fluid ejection device, comprising:
a plurality of actuators to eject the fluid;
a plurality of analog delay circuits coupled in series and coupled to the plurality of actuators;
fire logic coupled to the plurality of analog delay circuits to provide a fire signal to the plurality of analog delay circuits to drive the plurality of actuators;
a bias circuit coupled to the plurality of analog delay circuits to provide a bias signal to each of the analog delay, the bias signal to effect delay in each of the analog delay circuits; and
configuration logic circuit coupled to the bias circuit to disable the bias signal.

23. The fluid ejection device of claim 22 comprising a plurality of fluid ejection dice.

24. The fluid ejection device of claim 22 comprising a print substance reservoir.

25. The fluid ejection device of claim 22 wherein the configuration logic circuit is configured to disable the bias signal upon receipt of a configuration signal.

26. The fluid ejection device of claim 22 wherein test logic circuit coupled to the plurality of actuators measures a current in the plurality of actuators.

27. An integrated circuit for a printhead, the integrated circuit comprising:
a plurality of actuators to eject a print substance;
a plurality of delay circuits coupled in series and coupled to the plurality of actuators to selectively effect a signal delay;
fire logic coupled to the plurality of delay circuits to provide a fire signal to the plurality of analog delay circuits to drive the plurality of actuators; and
configuration logic circuit coupled to the delay circuit to disable the selective delay.

28. The integrated circuit of claim 27 wherein the fire signal corresponds with a data packet applied to the actuators.

29. The integrated circuit of claim 27 wherein the plurality of delay circuits includes a plurality of analog delay circuits and a bias circuit to provide a bias signal to effect the selective delay.

30. The integrated circuit of claim 27 wherein the plurality of actuators are coupled to an output pad.
